(19) United States
(12) Patent Application Publication
(10) Pub. No.: US 2008/0198599 A1
(43) Pub. Date: Aug. 21, 2008

(54) Combined glowing decorative structure

(76) Inventor: Chi-Shih Lai, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/707,965

(22) Filed: Feb. 20, 2007

(51) Int. Cl. F21S 13/14; F21V 21/26; F21V 21/32

(52) U.S. Cl. 362/252; 362/250; 362/806

(57) ABSTRACT

A combined glowing decorative structure includes a receiving body, having a receiving room inside, connecting with a controlling device and including at least one fixing portion mounted on at least one side; at least one extension, received in the receiving room of the receiving body and having a connecting portion for connecting with the corresponding fixing portion; and a glowing assembly, electrically connecting to the controlling device on one end and spreading along the receiving body and the at least one extension. Accordingly, the receiving room of the receiving body can receive the extension and the fixing portion of the receiving body can connect with the connecting portion of the extension. Thereby, the receiving body and the at least one extension form a glowing decorative shape.

### BACKGROUND OF THE INVENTION

1. Field of the Invention

The present invention relates to a combined glowing decorative structure, and more especially to a combined glowing decorative structure in which decoration extensions can be packaged in a main body via a boxing method that allows the volume of the unassembled decoration to be reduced, thereby making the transportation and storage of the combined glowing decorative structure more convenient

2. Description of the Prior Art

As people pay greater attention to their living standards, they like to create a comfortable atmosphere in any place which they will inhabit for any length of time. Decorating interior spaces with a variety of decorations not only fills the space, but also adds joy to their lives, thereby improving often humdrum interior environments and creating a pleasant atmosphere that is conducive to living in. Especially during festivals, such as Thanksgiving, All Saints' Day, Christmas and so on, decorating interior spaces is a western custom that creates warm atmospheres and adds to the festive nature of the celebration.

However, as globalization continues and the international division of labor deepens, the places where decorations are manufactured are usually far away from the places where the decorations are sold and used. Usually the decorations are manufactured in one country and sold or used in another. For example, products manufactured in China or South East Asia are often sold in North America or Europe. As such, the manufactured decorations usually need to be transported by sea, air or land before they arrive in the places where they are to be sold or used. Because the decorations usually have large volumes and irregular shapes (such as decorations with extended arms or long bending tails), packaging costs and transportation costs are quite high.

To reduce the costs of packaging and transportation, manufacturers often separate a decoration into a plurality of elements and then repackage the elements in a new arrangement to reduce the packaging volume and reduce the amount of required packaging materials. Furthermore, because reduction of a single packaging volume can increase the total quantity of decorations stored in the same container, efficiency of transportation is improved and the costs of packaging and transportation can be further reduced.

Although the decoration structures described above can be separated into a plurality of elements to be packaged in order to reduce packaging volume and increase the total transportation quantity of containers, the decoration structures have shortcomings as described below:

1. The above prior decoration structure can be separated into a plurality of elements for packaging. However, each element still has a basic volume and occupies a basic space, so no matter how many elements the decoration structure can be separated into, or how many packaging arrangement modes are projected, the efficacy of reducing volume is only achieved by increasing the density of the packaging, meanwhile the actual total volume is unchanged. Hence, this method only partly achieves the efficacy of reducing packaging materials; the packaging costs cannot be further substantially reduced. The most common packaging material is paper. As costs of raw material rise and environmental consciousness improves, packaging costs will only continue to rise.

2. No matter how many elements the above prior decoration structure can be separated into, or how many packaging arrangement modes are projected, though the packaging volume is reduced, the actual total volume of the decoration is unchanged so that the total quantity of the decorations stored in a same container cannot be substantially increased. Because energy costs in the international market are high, if the total transportation quantity per unit container cannot increase, transportation costs will increase, which makes the decorations less competitive.

3. The above prior decoration structures can help people to improve uninspiring interior environments, add joy to their lives and create pleasant atmospheres by changing the modeling, fittings and movements of the decorations. However, the prior decorations only can bring about these effects in very bright conditions. At night, or in other dark conditions, the decorations are invisible and do not improve interior environments, even if they are decorated beautifully. People today pay attention to aesthetic tastes and desire that their decorations have more color and luster, and even lighting effects, to meet the desire for improving their living environments.

4. In cities, conventional families have limited living space, so storage space is reduced greatly. Since the actual total volume of the above prior decoration structures are unchanged after the decoration structures are separated into a plurality of elements for storage, the decorations still occupy a certain amount of space. So how to reduce the storage volume of the decorations is a considerable problem for users.

Hence, the inventors of the present invention believe that the shortcomings described above are able to be improved upon and suggest the present invention as being of a reasonable design and as an effective improvement based on deep research and thought.

### SUMMARY OF THE INVENTION

An object of the present invention is to provide a combined glowing decorative structure which can package decoration extensions in a main body via a boxing method that reduces the volume of the unassembled decoration for transportation and storage.

To achieve the above-mentioned object, a combined glowing decorative structure in accordance with the present invention is disclosed. The combined glowing decorative structure includes a receiving body, having a receiving room inside, connected with a controlling device and mounting at least one fixing portion on at least one side; at least one extension, allowed to be received in the receiving room of the receiving body and each having a connecting portion for connecting with the corresponding fixing portion; and a glowing assembly, electrically connected with the controlling device on one end and spread along the receiving body and the at least one extension.

Accordingly, the present invention provides the receiving room of the receiving body to receive the at least one extension in and provides the at least one fixing portion of the receiving body to connect with the connecting portion of the at least one extension. Thereby the receiving body and the at least one extension form a glowing decorative shape.

To further understand technical contents, methods and efficacy of the present invention, please refer to the following detailed description and drawings related the present invention. It is believed that the objects, features and points of the present invention can be deeply understood. However, the drawings are only to be used as references and explanations, not to limit the present invention.

### BRIEF DESCRIPTION OF THE DRAWINGS

FIG. 1 is an exploded perspective view of a combined glowing decorative structure in accordance with the present invention;

FIG. 2 is an assembled perspective view of the combined glowing decorative structure in accordance with the present invention;

FIG. 3 is a partially exploded perspective view of a receiving body and a head extension of the combined glowing decorative structure in accordance with the present invention;

FIG. 4 is a partially exploded perspective view of the receiving body and an upper limb extension of the combined glowing decorative structure in accordance with the present invention;

FIG. 5 is a partially exploded perspective view of the receiving body and a lower limb extension of the combined glowing decorative structure in accordance with the present invention;

FIG. 6 is a perspective view of an embodiment of the combined glowing decorative structure in accordance with the present invention, in an assembled state;

FIG. 7 is a perspective view of the embodiment of the combined glowing decorative structure in accordance with the present invention, in a packaged state;

FIG. 8 is a block diagram of a controlling device of the combined glowing decorative structure in accordance with the present invention;

FIG. 9 is a circuit wiring diagram of the controlling device and glowing elements of the combined glowing decorative structure in accordance with the present invention; and

FIG. 10 is an assembled perspective view of a second embodiment of the combined glowing decorative structure in accordance with the present invention.

### DETAILED DESCRIPTION OF THE INVENTION

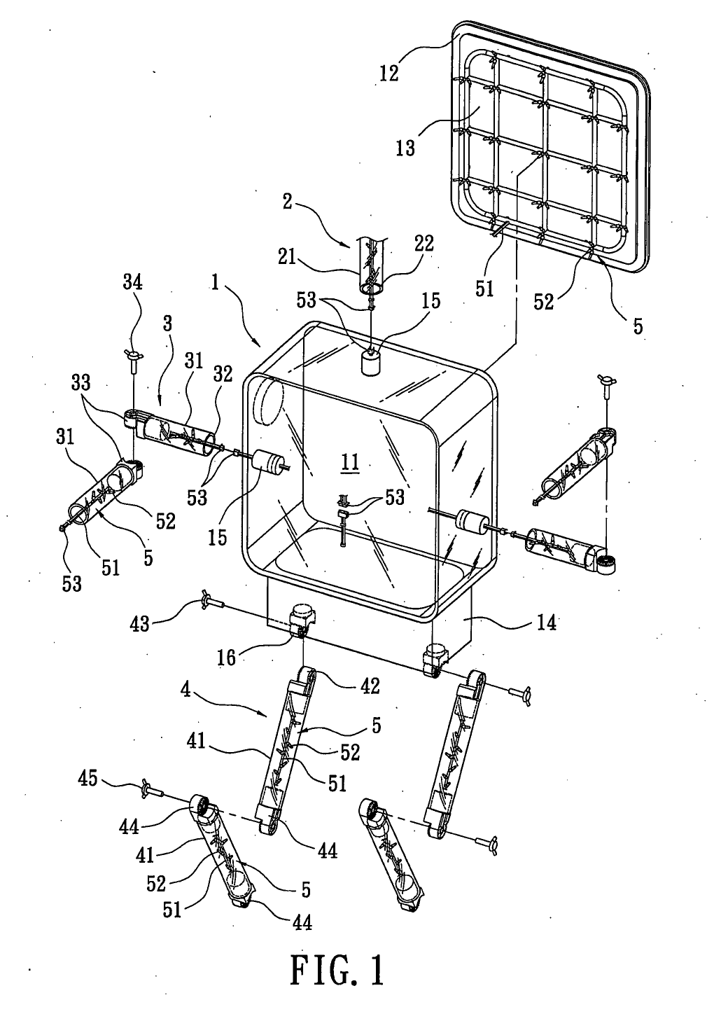

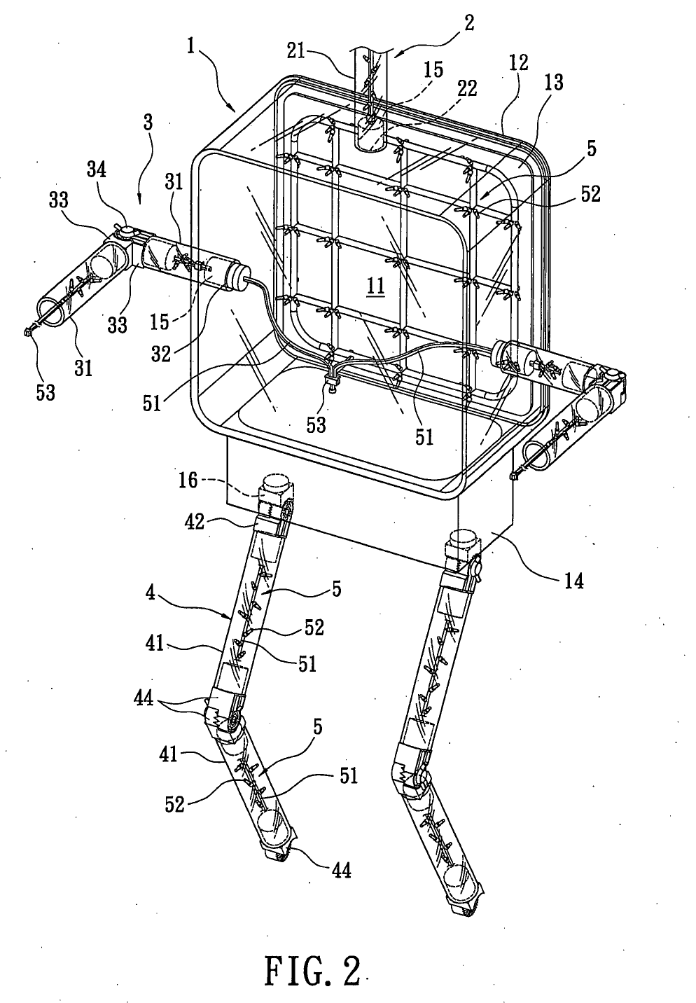

Please refer to FIG. 1 and FIG. 2, in which a combined glowing decorative structure in accordance with a preferred embodiment of the present invention is shown. The combined glowing decorative structure includes a receiving body 1, a head extension 2, two upper limb extensions 3, two lower limb extensions 4, and a glowing assembly 5.

The receiving body 1 is a enclosure body made of transparent material with a receiving room 11 inside. The receiving body 1 has a movable cover 12 made of transparent material corresponding to at least one side of the receiving room 11 and a light frame 13 on an inward side of the movable cover 12. A controlling device 14 connects with the receiving body 1. The receiving body 1 respectively mounts first fixing portions 15 on a top surface, a left side, and a right side thereof. The first fixing portions 15 are shafts. Two second fixing portions 16 are mounted on a bottom of the receiving body 1. The second fixing portions 16 are coronary gears. Additionally, the receiving body 1 has a plurality of modeling units with facial features 17 (such as eyes, a nose, a mouth and so on) on a front side.

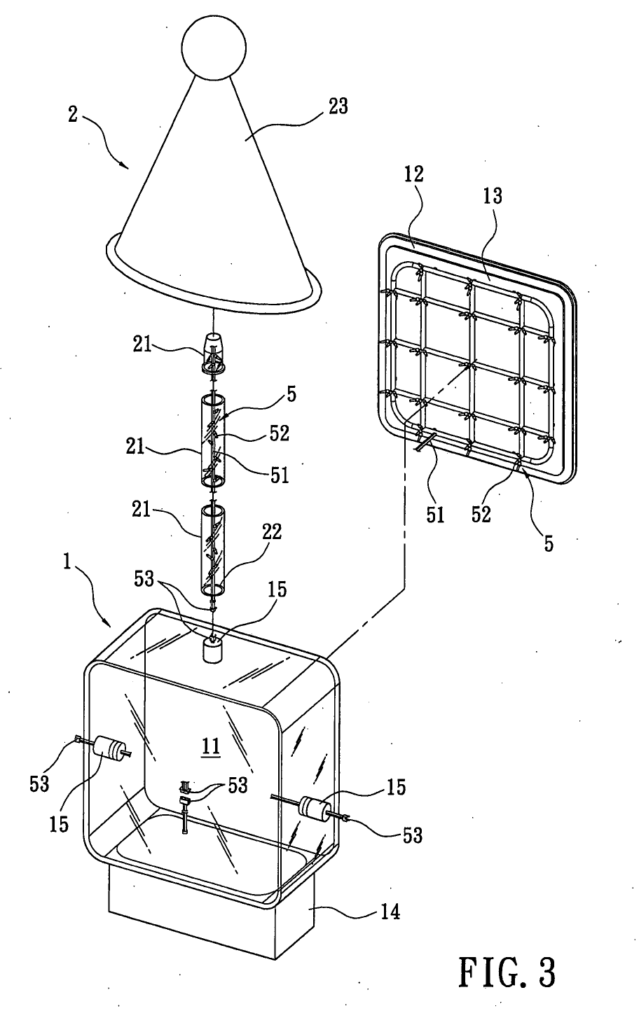

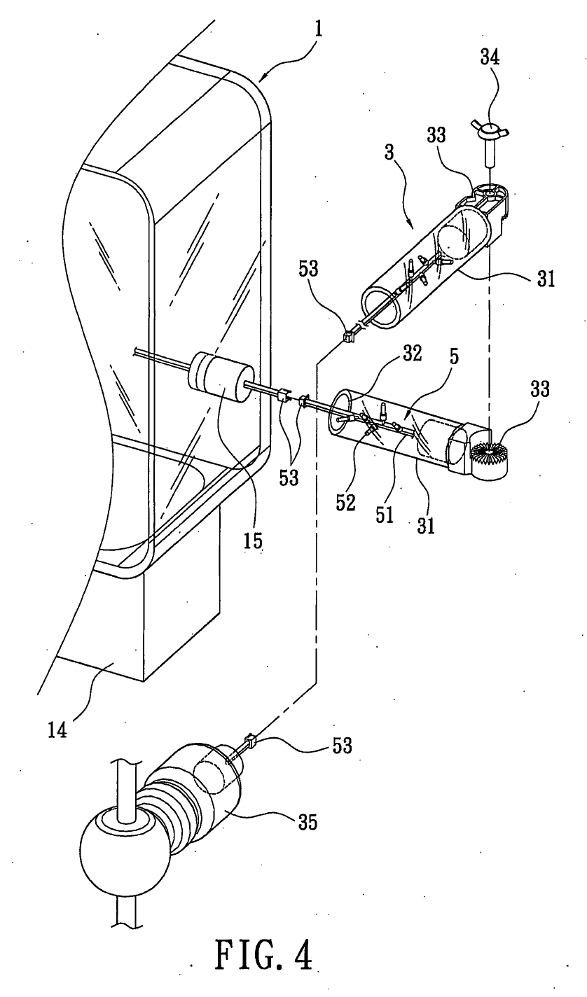

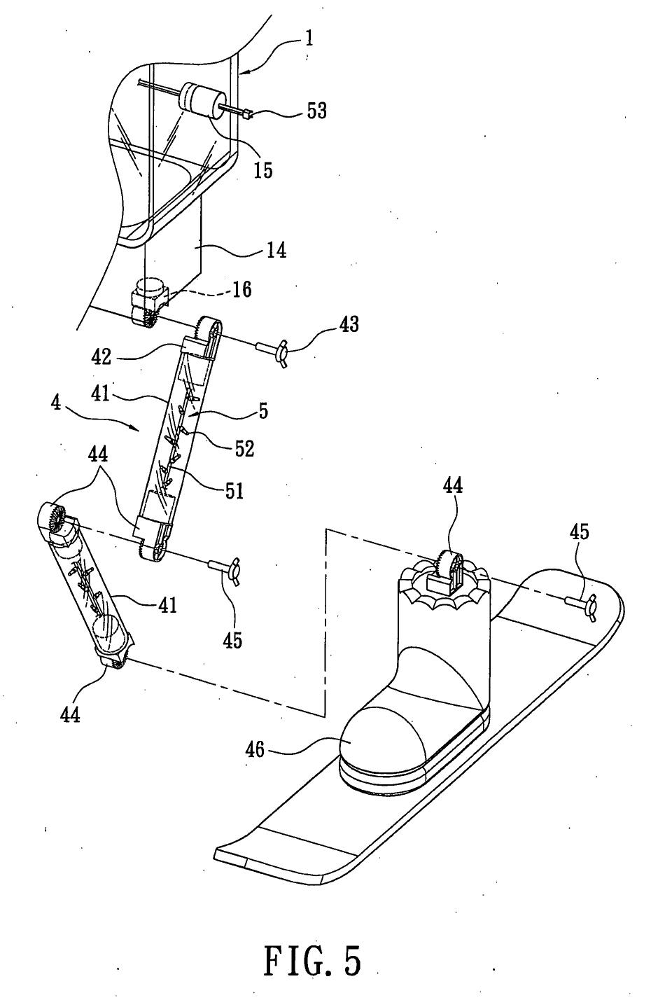

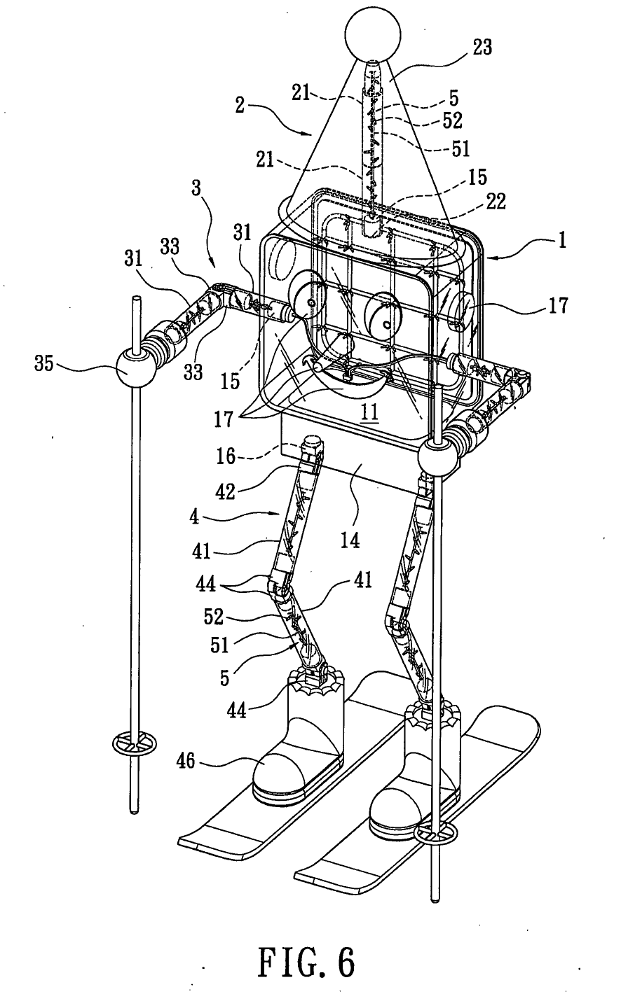

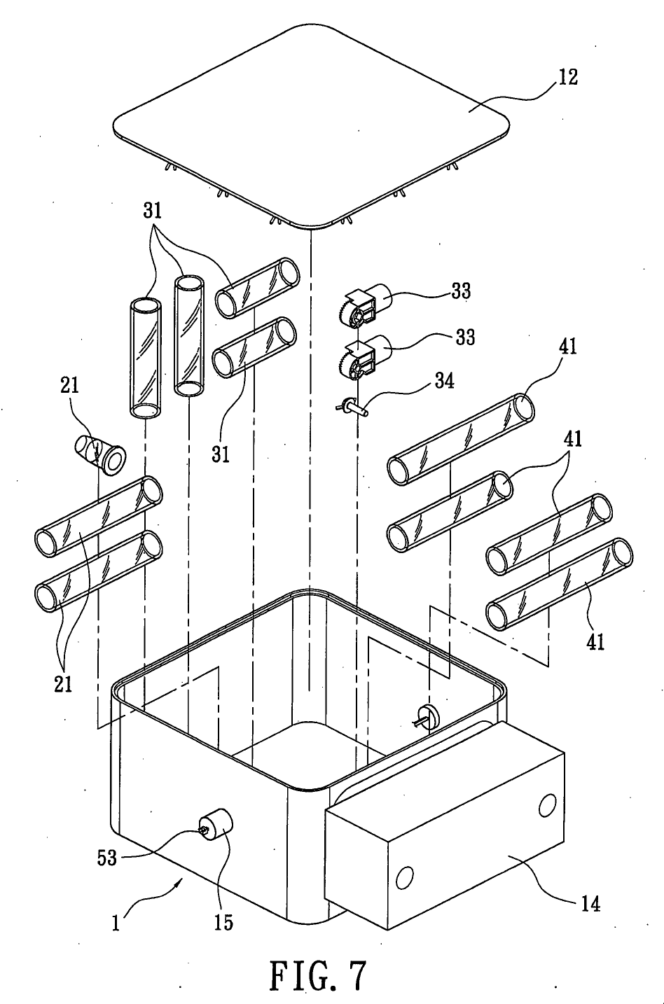

Please also refer to FIGS. 3-7. The head extension 2, the two upper limb extensions 3, and the two lower limb extensions 4 can all be received in the receiving room 11 of the receiving body 1. The head extension 2 has a first connecting portion 22 formed by sleeving grooves. The first connecting portion 22 connects with a corresponding first fixing portion 15. The head extension 2 has at least a first pipe 21 or more than two first pipes 21 connecting with each other. The first pipe 21 of the head extension 2 can engage with a modeling unit with hat 23.

The two upper limb extensions 3 have second connecting portions 32 formed by sleeving grooves. The second connecting portions 32 can respectively connect with the corresponding first fixing portions 15. Each upper limb extension 3 is formed by two second pipes 31 pivotedly connecting with each other. The ends of the two second pipes 31 which connect with each other respectively have first pivoted portions 33 which are formed by coronary gears and engage with each other. A first combined element 34 (such as a bolt, a rivet, or so on) pivotedly fixes the two first pivoted portions 33 so that the two second pipes can turn relative to each other. Thereby the pivoted connection is achieved. The second pipes 31 of the upper limb extensions 3 can engage with modeling units with hands 35.

The two lower limb extensions 4 have third connecting portions 42 formed by coronary gears. The third connecting portions 42 can respectively engage with the corresponding second fixing portions 16. The second fixing portions 16 and the third connecting portions 42 are pivotedly fixed via second combined elements 43 (such as bolts, rivets, or so on) so that the third connecting portions can turn relative to the second fixing portion 16. Each lower limb extension 4 is formed by two third pipes 41 pivotedly connecting with each other. The ends of the two third pipes 41 which connect with each other respectively have second pivoted portions 44 which are formed by coronary gears and engage with each other. A third combined element 45 (such as a bolt, a rivet, or so on) pivotedly fixes the two second pivoted portions 44 so that the two third pipes 41 can turn relative to each other. Thereby the pivoted connection is achieved. The third pipes 41 of the lower limb extensions 4 can engage with modeling units with feet 46.

The glowing assembly 5 includes a plurality of glowing elements 52 mounted on a plurality of flexible wire 51. The glowing elements 52 can be LED lights or light bulbs, etc. One end of one flexible wire 51 electrically connects to the controlling device 14. Two connecting ends of each flexible wire 51 respectively have corresponding connectors 53. The connectors 53 of the many flexible wires 51 can be mounted on the receiving body 1. The flexible wires 51 electrically connect with each other via the connectors 53 on the connecting ends thereof and spread along the light frame 13 on the inward side of the movable cove 12 in the receiving room 11 of the receiving body 1, the first pipe 21 of the head extension 2, the second pipes 31 of the upper limb extensions 3, and the third pipes 41 of the lower limb extensions 4.

Please refer to FIGS. 1, 2, 6, 7. When assembled, the head extension 2, the two upper limb extensions 3 and the two lower limb extensions 4 are respectively mounted around the receiving body 1 via the first fixing portions 15 and the second fixing portions 16 to form a combined modeling decoration. The flexible wires 51 of the glowing assembly 5 connect each other via the connectors 53 of the ends thereof that engage with each other. The flexible wire 51 spread through the receiving body 1, the first pipe 21 of the head extension 2, the second pipes 31 of the two upper limb extensions 3, and the third pipes 41 of the two lower limb extensions 4. The controlling device 14 controls the glowing elements 52 of the glowing assembly 51 to glow. During packaging, transportation and storage, the head extension 2, the two upper limb extensions 3 and the two lower limb extensions 4 can be received in the receiving room 11 of the receiving body 1 from the movable cover 12 to reduce their volume.

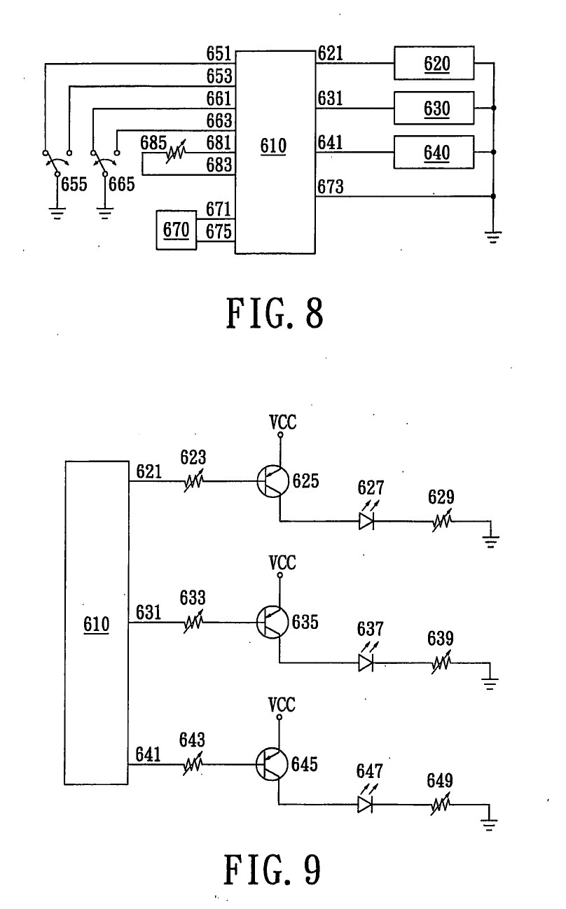

Since the glowing assembly of the present invention has lamps with changeable lamplights, the present invention further provides a control circuit to control the controlling device 14 of the glowing assembly 5 to describe the operation of the LED glowing elements 52. Please refer to FIG. 8.

The control circuit which controls the controlling device 14 includes a control chip 610, a red light group 620, a blue light group 630, a green light group 640, a power supply 670, and a variable resistor 685 for controlling an action-time of the circuit. The power supply 670 provides a DC (direct current) source via a pin 671, and provides an AC (alternating current) source for the control chip 610 via a pin 675 so that the control chip 610 can further control run-sequences and glowing actions of the red light group 620, the blue light group 630, and the green light group 640, and connect to the ground via a pin 673.

The control chip 610 controls the red light group 620 via a pin 621, controls the blue light group 630 via a pin 631, and controls the green light group 640 via a pin 641. The other ends of the red light group 620, the blue light group 630, and the green light group 640 connect to the ground.

The control chip 610 further provides pins 651, 653 as controlling switch points, thereby users switch the running circuits of the LED glowing elements 52 by switching a first switch 655 which in turn changes the color of the LED glowing elements 52. The embodiment has two or three color changes. In other words, when the first switch 655 switches to the pin 651, the control chip 610 will control two groups of the red light group 620, the blue light group 630, and the green light group 640 to change while the other group remains unchanged.

The control chip 610 can control the run modes of the LED glowing elements 52, and the change modes of the LED glowing elements 52, by switching the connection of the pins 661, 663 via a second switch 665. For example, assuming that the pin 661 controls the red light group 620, the blue light group 630 or the green light group 640 to twinkle alternately and continuously, then the pin 663 controls the red light group 620, the blue light group 630, or the green light group 640 to gradually brighten or dim. When the second switch 665 switches to the pin 661 so that the pin 661 connects to the ground, under the control of the control chip 610, the red light group 620, the blue light group 630, or the green light group 640, will twinkle alternately and continuously. When the second switch 665 switches to the pin 663 so that the pin 663 connects to the ground under the control of the control chip 610, the red light group 620, the blue light group 630 or the green light group 640 gradually brightens or dims.

Because a variable resistor 685 connects to pins 681, 683, the control chip 610 can control the action-time of the red light group 620, the blue light group 630, or the green light group 640 according to the variety of the variable resistor 685.

The control circuits in the red light group 620, the blue light group 630, or the green light group 640 are shown in FIG. 9.

The red light group 620 includes variable resistors 623, 629, a control transistor 625, and a red LED light 627. The blue light group 630 includes variable resistors 633, 639, a control transistor 635, and a blue LED light 637. The green light group 640 includes variable resistors 643, 649, a control transistor 645, and a green LED light 647.

Assuming that the first switch 655 switches to the pin 651 so that the pin 651 connects to the ground, the control chip 610 controls the red light group 620, the blue light group 630, and the green light group 640 to work. Accordingly, when the control transistor 625 connects to a certain voltage source VCC, the control chip 610 can transmit signals to the control transistor 625 via the pin 621 to ensure that the control transistor 625 conducts and further makes the red LED light 627 emits. The switch directions of the first switch 655 can be predetermined.

In the same way, the control chip 610 can transmit signals to the control transistor 635 via the pin 631 to ensure that the control transistor 635 conducts and further makes the blue LED light 637 conduct. Alternatively, the control chip 610 can transmit signals to the control transistor 645 via the pin 641 to ensure that the control transistor 645 conducts and further makes the green LED light 647 emits.

The action-time of each LED light is determined by a variable resistor 685 and action changes of each LED light are controlled based upon the switching of the second switch 665.

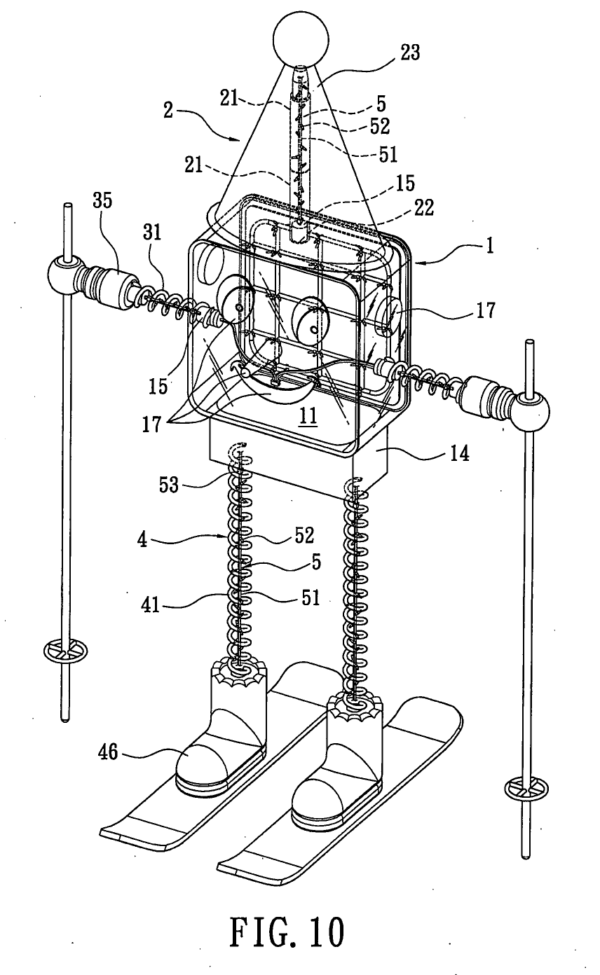

A second embodiment of the present invention is shown in FIG. 10. For the second embodiment of the present invention, the head extension 2, the upper limb extensions 3 and the lower limb extensions 4 are formed by elastic elements, respectively. The glowing assembly 5 is spread on the head extension 2, the upper limb extensions 3, and the lower limb extensions 4 by means of winding.

Accordingly, the features and efficacy of the present invention can be summed up as follows:

1. The present invention forms the receiving room 11 inside the receiving body I for storing the head extension 2, the upper limb extensions 3 and the lower limb extensions 4. Thereby the actual total volume is reduced, packaging costs are lowered and total transportation quantity per unit container can be increased to make the combined glowing decorative structures more cost competitive.

2. The present invention can be assembled and separated by users in a DIY (Do It Yourself) mode. In an idle state, the present invention can store the head extension 2, the upper limb extensions 3, and the lower limb extensions 4 in the receiving room 11 inside the receiving body 1 to reduce the volume and save storage space.

3. The present invention matches the modeling units with facial features 17, the modeling units with hat 23, the modeling units with hands 35 and the modeling units with feet 46, and the head extension 2, the upper limb extensions 3 and the lower limb extensions 4 can be adjusted to turn, so that the combined modeling is more three-dimensional and has more expressions and actions.

4. The present invention further has the glowing assembly 5 for decorating the modeling body and the pipes of the four limbs to create a better atmosphere in a decorated space.

What is disclosed above is only the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A combined glowing decorative structure, comprising:
a receiving body, having a receiving room inside, connecting with a controlling device with at least one fixing portion mounted on at least one side;
at least one extension, allowed to be received in the receiving room of the receiving body and having a connecting portion for connecting with the corresponding fixing portion; and
a glowing assembly, electrically connecting to the controlling device on one end and spreading along the receiving body and the at least one extension;
wherein the receiving room of the receiving body receives the at least one extension and the at least one fixing portion of the receiving body connected with the connecting portion of the at least one extension thereby the receiving body and the at least one extension form a glowing decorative shape.

2. The combined glowing decorative structure as claimed in claim 1, wherein the receiving body is an enclosure body and includes a movable cover corresponding to at least one side of the receiving room.

3. The combined glowing decorative structure as claimed in claim 2, wherein the glowing assembly spreads along an inward side of the movable cover.

4. The combined glowing decorative structure as claimed in claim 3, wherein a light frame is mounted on the inward side of the movable cover and the glowing assembly spreads along the light frame.

5. The combined glowing decorative structure as claimed in claim 1, wherein the fixing portion is a fixing shaft and the connecting portion is a sleeving groove that correspondingly pivotedly engages with the fixing portion.

6. The combined glowing decorative structure as claimed in claim 1, wherein the fixing portion and the connecting portion are corresponding coronary gears which engage with each other, and pivotedly connect by a locking portion, thereby the connecting portion turns relative to the fixing portion.

7. The combined glowing decorative structure as claimed in claim 1, wherein the extension is formed by a plurality of pipes connecting with each other.

8. The combined glowing decorative structure as claimed in claim 7, wherein the glowing assembly spreads through the pipes.

9. The combined glowing decorative structure as claimed in claim 1, wherein each extension has an elastic element.

10. The combined glowing decorative structure as claimed in claim 1, wherein the glowing assembly has a plurality of flexible wires, a plurality of glowing elements are mounted on the flexible wires, and each flexible wire has a corresponding connector on each connecting end.
